(19) United States
(12) Patent Application Publication
(10) Pub. No.: US 2015/0242182 A1
(43) Pub. Date: Aug. 27, 2015

(54) VOICE AUGMENTATION FOR INDUSTRIAL OPERATOR CONSOLES

(71) Applicant: Honeywell International Inc., Morristown, NJ (US)

(72) Inventor: Rohan McAdam, Yetholme (AU)

(73) Assignee: Honeywell International Inc., Morristown, NJ (US)

(21) Appl. No.: 14/188,419

(22) Filed: Feb. 24, 2014

(51) Int. Cl. G06F 3/16; G05B 15/02

(52) U.S. Cl. CPC G06F 3/165; G05B 15/02

(57) ABSTRACT

A method includes receiving first audio data from an operator associated with an industrial control and automation system. The method also includes identifying one or more recognition events associated with the first audio data, where each recognition event is associated with at least a portion of the first audio data that has been recognized using at least one grammar. In addition, the method includes performing one or more actions using the industrial control and automation system based on the one or more recognition events. The at least one grammar is based on information associated with the industrial control and automation system. The method could further include generating the at least one grammar. The information associated with the industrial control and automation system could include definitions of process variables, controllers, assets, trends, alarms, reports, and displays available in the industrial control and automation system.

### TECHNICAL FIELD

This disclosure relates generally to industrial control and automation systems. More specifically, this disclosure relates to voice augmentation for industrial operator consoles.

### BACKGROUND

Industrial process control and automation systems are often used to automate large and complex industrial processes. These types of control and automation systems routinely include sensors, actuators, and controllers. The controllers typically receive measurements from the sensors and generate control signals for the actuators.

These types of control and automation systems also typically include numerous operator consoles. Operator consoles are often used to receive inputs from operators, such as setpoints for process variables in an industrial process being controlled. Operator consoles are also often used to provide outputs to operators, such as to display warnings, alarms, or other information associated with the industrial process being controlled. Operator consoles are typically based around conventional desktop computer interactions, primarily using graphical displays, keyboards, and pointing devices such as mice and trackballs. Touch interaction has also been used with some operator consoles.

### SUMMARY

This disclosure provides voice augmentation for industrial operator consoles.

In a first embodiment, a method includes receiving first audio data from an operator associated with an industrial control and automation system. The method also includes identifying one or more recognition events associated with the first audio data, where each recognition event is associated with at least a portion of the first audio data that has been recognized using at least one grammar. In addition, the method includes performing one or more actions using the industrial control and automation system based on the one or more recognition events. The at least one grammar is based on information associated with the industrial control and automation system.

In a second embodiment, an apparatus includes at least one processing device. The least one processing device is configured to receive first audio data from an operator associated with an industrial control and automation system, identify one or more recognition events associated with the first audio data, and initiate performance of one or more actions using the industrial control and automation system based on the one or more recognition events. Each recognition event is associated with at least a portion of the first audio data that has been recognized using at least one grammar. The at least one grammar is based on information associated with the industrial control and automation system.

In a third embodiment, a non-transitory computer readable medium embodies a computer program. The computer program includes computer readable program code for receiving first audio data from an operator associated with an industrial control and automation system, identifying one or more recognition events associated with the first audio data, and initiating performance of one or more actions using the industrial control and automation system based on the one or more recognition events. Each recognition event is associated with at least a portion of the first audio data that has been recognized using at least one grammar. The at least one grammar is based on information associated with the industrial control and automation system.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial control and automation system according to this disclosure;

FIGS. 2 and 3 illustrate an example operator console with voice augmentation according to this disclosure; and

FIG. 4 illustrates an example method for using an operator console with voice augmentation according to this disclosure.

### DETAILED DESCRIPTION

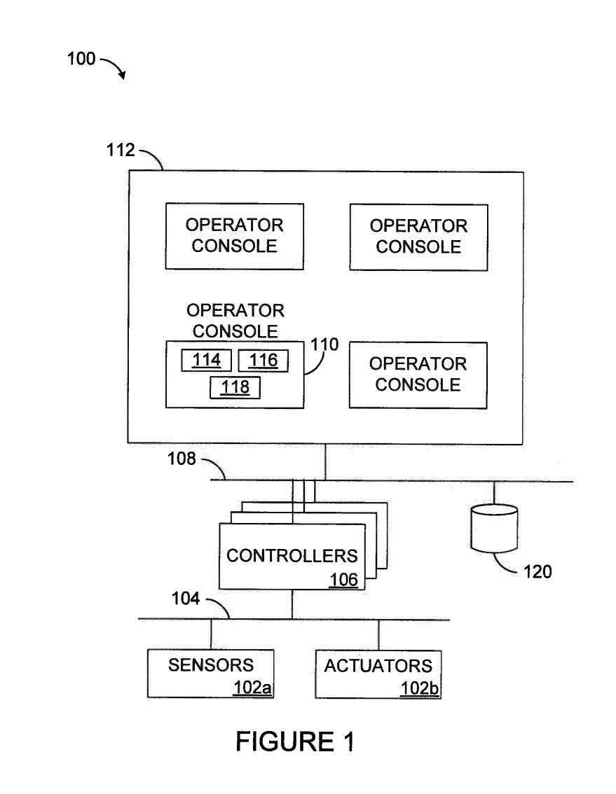

FIGS. 1 through 4, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example industrial control and automation system 100 according to this disclosure. As shown in FIG. 1, the system 100 includes various components that facilitate production or processing of at least one product or other material. For instance, the system 100 can be used to facilitate control over components in one or multiple industrial plants. Each plant represents one or more processing facilities (or one or more portions thereof), such as one or more manufacturing facilities for producing at least one product or other material. In general, each plant may implement one or more industrial processes and can individually or collectively be referred to as a process system. A process system generally represents any system or portion thereof configured to process one or more products or other materials in, some manner.

In FIG. 1, the system 100 includes one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent at least one Ethernet network, electrical signal network (such as a HART or FOUNDATION FIELDBUS network), pneumatic control signal network, or any other or additional type(s) of network(s).

Various controllers 106 are coupled directly or indirectly to the network 104. The controllers 106 can be used in the system 100 to perform various functions. For example, a first set of controllers 106 may use measurements from one or more sensors 102a to control the operation of one or more actuators 102b. A second set of controllers 106 could be used to optimize the control logic or other operations performed by the first set of controllers. A third set of controllers 106 could be used to perform additional functions.

Controllers 106 are often arranged hierarchically in a system. For example, different controllers 106 could be used to control individual actuators, collections of actuators forming machines, collections of machines forming units, collections of units forming plants, and collections of plants forming an enterprise. A particular example of a hierarchical arrangement of controllers 106 is defined as the “Purdue” model of process control. The controllers 106 in different hierarchical levels can communicate via one or more networks 108 and associated switches, firewalls, and other components.

Each controller 106 includes any suitable structure for controlling one or more aspects of an industrial process. At least some of the controllers 106 could, for example, represent multivariable controllers, such as Robust Multivariable Predictive Control Technology (RMPCT) controllers or other type of controllers implementing model predictive control (MPC) or other advanced predictive control (APC).

Access to and interaction with the controllers 106 and other components of the system 100 can occur via various operator consoles 110. As described above, each operator console 110 could be used to provide information to an operator and receive information from an operator. For example, each operator console 110 could provide information identifying a current state of an industrial process to the operator, including warnings, alarms, or other states associated with the industrial process. Each operator console 110 could also receive information affecting how the industrial process is controlled, such as by receiving setpoints for process variables controlled by the controllers 106 or by receiving other information that alters or affects how the controllers 106 control the industrial process.

Multiple operator consoles 110 can be grouped together and used in one or more control rooms 112. Each control room 112 could include any number of operator consoles 110 in any suitable arrangement. In some embodiments, multiple control rooms 112 can be used to control an industrial plant, such as when each control room 112 contains operator consoles 110 used to manage a discrete part of the industrial plant.

Each operator console 110 includes any suitable structure for displaying information to and interacting with an operator. For example, each operator console 110 could include one or more processing devices 114, such as one or more microprocessors, microcontrollers, digital signal processors, application specific integrated circuits, field programmable gate arrays, or discrete logic. Each operator console 110 could also include one or more memories 116 storing instructions and data used, generated, or collected by the processing device(s) 114. Each operator console 110 could further include one or more network interfaces 118 that facilitate communication over at least one wired or wireless network, such as one or more Ethernet interfaces or wireless transceivers.

In addition, the system 100 includes one or more databases 120. Each database 120 can be used to store any suitable information related to an industrial process or a control system used to control the industrial process. For example, as described in more detail below, one or more databases 120 can be used to store distributed control system (DCS) configuration information and real-time DCS information. Each database 120 represents any suitable structure for storing and retrieving information.

Operator consoles 110 often provide a rich environment for monitoring and controlling industrial processes. However, the amount of information that operators interact with places heavy demands on current operator consoles' interaction mechanisms (such as graphical displays, keyboards, and pointing devices). This can become a problem, for example, when a complex task requires most or all of the space on an operator console's display to present information for the task. A problem can arise if the operator needs additional information beyond that normally displayed for the task or needs to perform an auxiliary action not catered to by the current arrangement of information on the graphical display. As a particular example, an operator may need to access process information regarding unusual upstream or downstream operations or add entries to a shift log. Operators may be forced to disrupt the layout of information related to their primary task on a display or distract someone else and ask them to look up and provide needed information.

Another problem with current operator consoles' interaction mechanisms is that they often constrain an operator to sit or stand directly at the operator console within arm's reach of a keyboard, mouse, or other input device. This makes it difficult for operators to adopt more varied postures, such as sitting back from a console, in order to help with operator fatigue during long work shifts. It is also typically difficult for an operator to step away from an operator console to take a break without losing situational awareness.

Current interaction mechanisms for operator consoles neglect the use of voice as an additional interaction modality both for input and output. This disclosure integrates voice interactions into one or more operator consoles 110. This can be achieved by integrating a speech recognition engine and a speech synthesizer into an industrial control and automation system. The speech recognition engine can recognize relevant grammars, such as those derived from an organization of information in the underlying control system and tasks commonly performed by operators. The speech synthesizer provides voice annunciations for operators, such as annunciations identifying query results, notifications, and alarms.

This approach enables a number of applications. For example, an operator can issue queries for process information via voice commands and listen to synthesized speech responses. As other examples, an operator console 110 can provide synthesized speech notifications of alarms and process parameter changes and record log book entries via voice commands and dictation. In addition, an operator can control the display of information on one or more display screens using voice commands.

Voice interaction allows an operator to work more efficiently and comfortably while at an operator console 110, such as by allowing interaction with the console 110 while sitting back from the console 110 in a relaxed posture. With the use of a headset having one or more microphones and one or more headphones, an operator can also maintain situational awareness while away from an operator console 110 through voice-based notifications.

Additional details regarding the use of voice augmentation in operator consoles 110 are provided below. Note that operator consoles 110 can use voice augmentation to support a very large number of possible interactions with one or more operators. While this disclosure provides numerous examples of interactions with operators involving voice augmentation, this disclosure is not limited to these specific examples.

Although FIG. 1 illustrates one example of an industrial control and automation system 100, various changes may be made to FIG. 1. For example, industrial control and automation systems come in a wide variety of configurations. The system 100 shown in FIG. 1 is meant to illustrate one example operational environment in which voice augmentation can be incorporated into or used with operator consoles. FIG. 1 does not limit this disclosure to any particular configuration or operational environment.

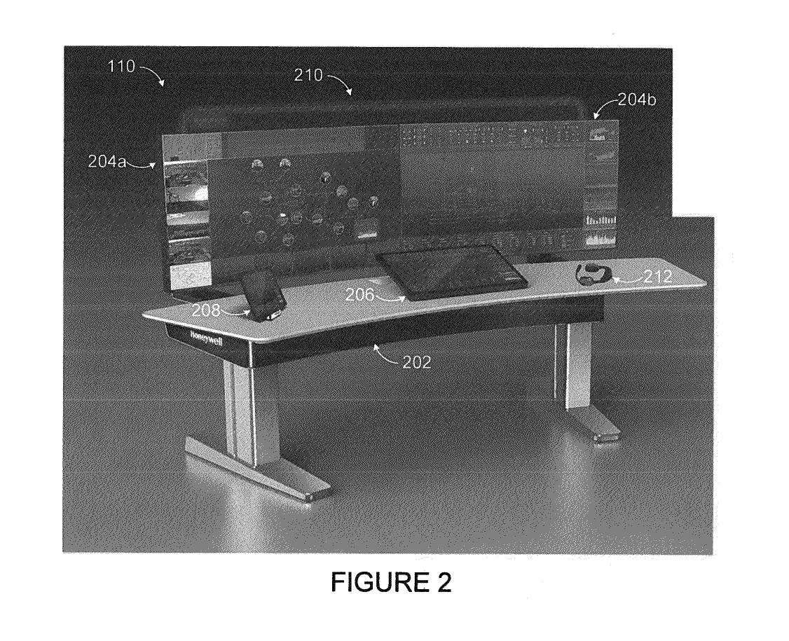

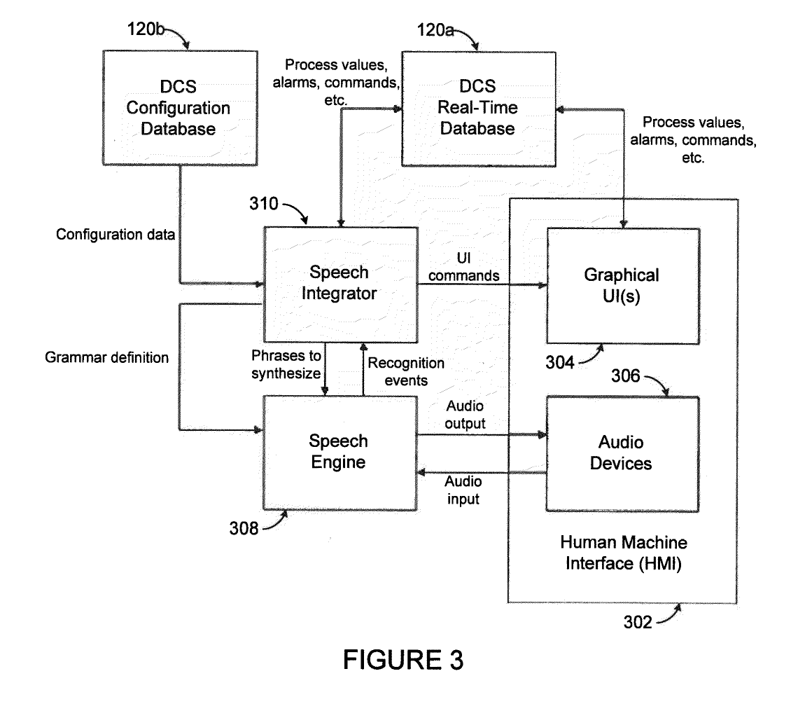

FIGS. 2 and 3 illustrate an example operator console 110 with voice augmentation according to this disclosure. As shown in FIG. 2, the operator console 110 is positioned on a desk 202. The desk 202 supports components of the operator console 110 and could be used to hold or retain electronics under the operator console 110.

The operator console 110 includes one or more graphical displays 204a-204b placed on, mounted to, or otherwise associated with the desk 202. The graphical displays 204a-204b can be used to present various information to an operator. For instance, the graphical displays 204a-204b could be used to display a graphical user interface (GUI) that includes diagrams of an industrial process being controlled and information associated with the current state of the industrial process being controlled. The GUI could also be used to receive information from an operator. Each graphical display 204a-204b includes any suitable display device, such as a liquid crystal display (LCD) or light emitting diode (LED) display. In this example, there are two graphical displays 204a-204b adjacent to and angled with respect to one another. However, an operator console 110 could include any number of graphical displays in any suitable arrangement.

The operator console 110 in this example also includes an additional display 206 and a mobile device 208. The additional display 206 here is placed on the desk 202 and can be positioned at an angle. The additional display 206 could represent a touchscreen that can be used to interact with the GUI in the graphical displays 204a-204b and to control the content on the graphical displays 204a-204b. The additional display 206 could also display additional information not presented on the graphical displays 204a-204b. The additional display 206 includes any suitable display device, such as an LCD or LED display or touchscreen. Note, however, that the use of the additional display 206 is optional and that other input devices (such as a keyboard) could be used.

The mobile device 208 can similarly be used to support interactions between an operator and GUIs presented in the displays 204a-204b, 206. For example, the mobile device 208 could include a touchscreen that can be used to control the content on the displays 204a-204b, 206 and to interact with the GUIs presented in the displays 204a-204b, 206. Moreover, the mobile device 208 could receive and display information to an operator, such as current process variable values or process states, when the operator moves away from the operator console 110. The mobile device 208 includes any suitable device that is mobile and that supports interaction with an operator console, such as a tablet computer. Note, however, that the use of the mobile device 208 is optional.

The operator console 110 further includes an ambient display 210, which in this example is positioned at the top of the graphical displays 204a-204b. The ambient display 210 can output light having different characteristic(s) to identify the current status of an industrial process (or portion thereof) being monitored or controlled using the operator console 110. For example, the ambient display 210 could output green light or no light when the current status of an industrial process or portion thereof is normal. The ambient display 210 could output yellow light when the current status of an industrial process or portion thereof indicates that a warning has been issued. The ambient display 210 could output red light when the current status of an industrial process or portion thereof indicates that an alarm has been issued. Note that other or additional characteristics of the ambient light can also be controlled, such as the intensity of light or the speed of transitions in the light. The ambient display 210 here represents an edge-lit glass segment or other clear segment, where one or more edges of the segment can be illuminated using an LED strip or other light source. Note, however, that the use of the ambient display 210 is optional.

In addition, the operator console 110 includes a headset 212. The headset 212 includes one or more headphones that can generate audio information for an operator and one or more microphones that can capture audio information from the operator. For example, the headset 212 can capture audible commands and queries spoken by the operator, and the headset 212 can provide audio responses or other messages to the operator. The headset 212 can include various other components, such as a “push to talk” button that triggers capturing of audio information by a microphone. The headset 212 includes any suitable structure that is worn on the head of an operator. The headset 212 could represent a wireless headset or a wired headset that is plugged into a suitable port of the operator console 110 or other component. Alternatively or in addition, speakers and microphones (such as a microphone array) could be integrated into the console 110 itself.

As shown in FIG. 3, a DCS real-time database 120a represents a repository of process data associated with operation of an industrial control and automation system. For example, the database 120a could store current and historical real-time process data, alarms, events, and notifications. Note that any other or additional information could be stored in the database 120a.

A DCS configuration database 120b represents a repository of data associated with the configuration of an industrial control and automation system. For example, the database 120b could store definitions of process variables, controllers, assets, trends, alarms, reports, and displays available in a DCS. Note that any other or additional information could be stored in the database 120b.

The operator console 110 includes various human machine interfaces (HMIs) 302, including one or more GUIs 304 and one or more audio devices 306. Each GUI 304 represents one or more interfaces that can be presented on the graphical displays 204a-204b. The GUIs 304 can be used to present schematic representations of process data, trends of process data, lists of alarms, or any other or additional process-related data. Interactions with the GUIs 304 could occur through various input devices, such as the display 206, a keyboard, a mouse, or a trackball.

The audio devices 306 represent devices used to present audio information to or receive audio information from an operator. For example, the audio devices 306 could include one or more speakers and one or more microphones. In particular embodiments, the audio devices 306 could be included in the headset 212 shown in FIG. 2. Note, however, that other implementations of the audio devices 306 could also be used. For instance, one or more speakers and/or one or more microphones may be mounted in the console hardware.

A speech engine 308 can receive audio inputs from and provide audio outputs to the audio devices 306. The audio inputs could include utterances spoken by an operator and captured by a microphone. The audio outputs could include speech that is synthesized from text or other data. As particular examples, the speech engine 308 could receive digitized speech from a headset 212, where the digitized speech represents queries, requests, and other utterances spoken by an operator wearing the headset 212. The speech engine 308 could also generate audio responses to the operator's queries and requests for presentation by the operator's headset 212.

A speech engine is typically configured to understand one or more “grammars” of utterances to be recognized by the speech engine. In ordinary situations, engineering the grammar for a speech engine is a complex and time-consuming task. However, in an industrial control and automation system, this disclosure recognizes that the voice inputs to an operator console 110 are often limited in scope. For example, the grammar to be learned by the speech engine 308 could be limited based on factors such as the organization of information or other information structures in the underlying control system and tasks commonly performed by operators in a given setting. As a result, information in the DCS configuration database 120b or other information related to the control system can be leveraged to greatly simplify the definition of a grammar for the speech engine 308.

The speech engine 308 includes any suitable structure for processing audio inputs and generating audio outputs. For example, the speech engine 308 could be implemented using software executed by the processing device(s) 114 of the operator console 110. In particular embodiments, the speech engine 308 could represent the speech engine included in the WINDOWS 7 or WINDOWS 8 operating system from MICROSOFT. Note that while the speech engine 308 is shown here as residing within an operator console 110, the speech engine 308 could reside in any other suitable location(s). For instance, the speech engine 308 could be located centrally within a network or located in a cloud, computing environment (such as one accessible over the Internet).

A speech integrator 310 ties the speech engine 308, the databases 120a-120b, and the GUIs 304 together. For example, the speech integrator 310 can receive configuration data from the database 120b and use the configuration data to define one or more grammars to be recognized by the speech engine 308. As particular examples, hierarchical asset and equipment models could be used to help define a structured query and command language.

The speech integrator 310 can also update a GUI 304 in response to one or more recognition events received from the speech engine 308 (such as recognized queries or commands). For instance, the speech integrator 310 can call up a particular GUI 304, move a GUI 304, or silence an alarm in response to recognition events from the speech engine 308. A recognition event could identify at least one word or phrase that has been recognized in incoming audio data from an operator.

The speech integrator 310 can further transmit or receive updates of process variables, alarms, commands, or other information to or from the database 120a in response to one or more recognition events. For example, the speech integrator 310 could change a controller setpoint or acknowledge an alarm based on recognition events from the speech engine 308.

In addition, the speech integrator 310 could generate phrases to be synthesized by the speech engine 308. The generated phrases could be based on updates received from the database 120a, such as process values, continual process value updates, or alarm annunciations.

The speech integrator 310 could be implemented in any suitable manner. For example, the speech integrator 310 could be implemented using software executed by the processing device(s) 114 of the operator console 110.

The following represents a few simple examples of the types of operator interactions that could be supported by the speech integrator 310. Note that specific numerical values, GUIs, and alarms given here are examples only.

| Use case | Example dialog |
|---|---|
| Display call up | Operator says: “Open FCCU 3 overview” |
| | Console response: Present FCCU 3 overview display |
| Moving displays | Operator says: “Move FCCU 3 overview to left |
| | screen” |
| | Console response: Present FCCU 3 overview display |
| | on the left screen of the console |
| Display readout | Operator says: “Read FCCU 3 overview velocities” |
| | Console response: State “FCCU 3 cyclone velocity is |
| | 46.54. Riser velocity is 12.6” |
| Alarm silencing | Operator says: “Silence alarms” |
| | Console response: Silence alarms |
| Alarm | Operator says: “Notify me of new alarms” |
| annunciation | Console response: State “OK, I will notify you of |
| | new alarms” |
| | . . . |
| | Console response: State “PV Hi alarm for FCCU 3 |
| | cyclone level” |
| Alarm | Operator says: “Acknowledge alarms for FC1234” |
| acknowledgement | Console response: Alarms for FC1234 are |
| | acknowledged |
| | Console response: State “Alarms for FC1234 have |
| | been acknowledged” |
| Voice comments | Operator says: “Add comment to alarm for FC1234” |
| | Console response: State “Go ahead” |
| | Operator says: “Alarm caused by incorrect field |
| | action” |
| | Console response: State “Your comment - Alarm |
| | caused by incorrect field action - added to alarm |
| | for FC1234” |
| Parameter query | Operator says: “Query FCCU 3 cyclone level” |
| | Console response: State “FCCU 3 cyclone level is |
| | 28.4 percent” |
| Parameter | Operator says: “Notify me of changes to FCCU 3 |
| updates | cyclone level” |
| | Console response: State “OK, I will notify you of |
| | changes to FCCU 3 cyclone level” |
| | . . . |
| | Console response: State “FCCU 3 cyclone level is |
| | 35.8%” |

Note that the use of voice augmentation for operator consoles 110 could be limited in scope. For example, voice interactions could be supported only for non-critical aspects of an industrial process. This may help to avoid situations where control of a critical aspect of the industrial process depends upon the ability of an operator console 110 to correctly interpret spoken commands. If the speech engine 308 has the ability to adapt over time and improve its recognition, use of voice augmentation could be extended to control over more critical aspects of the industrial process as operator confidence in the speech engine 308 increases.

The following are more specific example use cases of voice augmentation with an operator console 110. The following use cases are divided between use in a “console environment” and use in a “collaboration station environment.” The console environment represents a situation where an operator console 110 is used by a single operator (meaning there is a single speaker), possibly in a control room. 112 (which could be noisy or quiet). In these cases, a headset 212 can be worn by an operator, and most or all of the speaking detected by the operator console 110 could be directed at the console 110. The collaboration station environment represents a situation where a specialized operator console 110 (often with a large display) is used by multiple operators (meaning there are multiple speakers). A headset 212 is not typically used in these cases since there can be multiple people speaking, and often they are speaking more to each other than to the operator console 110. In these cases, the operator console 110 could be designed to respond to the operator who “speaks up” (speaks louder than the other speakers) or to respond to the operator who speaks a specified “trigger” word or phrase to attract the attention of the speech engine 308.

Console Environment, Ad Hoc Process Queries:

Assume an operator is working with a particular set of schematics but needs an additional piece of process information not on one of his or her current GUIs 304. Ordinarily, the operator would interrupt what he or she is doing, call up another GUI to check the information, and restore the schematics on the console to continue work. In accordance with this disclosure, the operator can use a voice query to access the information directly, such as by requesting the piece of process information and hearing the information read back. In this case, the grammar identified by the speech integrator 310 and used by the speech engine 308 could be built based on an asset model in the control system, and point descriptions can be used to make the experience easier for the operator. The grammar can also be based on the operator's Scope of Responsibility (SOR), which refers to the portion of a physical plant or process for which the operator is responsible. The SOR can be used to control access to information and functions in a system. An operator typically has full control over everything in his or her own SOR but may have only view access to another operator's SOR. Note that when a query relates to a specific process variable's value, the unit of measurement for the value could be standard or based on local usage (such as when a value is in “meters cubed per hour” or just “cubes”).

In this use case, the operator can become more efficient because his or her workflow is not interrupted by the need to navigate to other displays for ad hoc information. Also, this use case helps to avoid one operator asking another operator for information, which can interrupt the other operator's workflow.

Console Environment, Direct Display Navigation:

Assume an operator needs to call up a specific GUI that is not directly accessible from his or her current set of schematics. Ordinarily, the operator types the GUI name in a command zone. In accordance with this disclosure, the operator can use a voice command to directly call up the GUI. The grammar identified by the speech integrator 310 and used by the speech engine 308 could be built based on the set of GUIs defined for use at the operator console. Note that GUI names or descriptions could be used here. In this use case, more efficient navigation can be obtained when navigating across a GUI hierarchy compared to having to use a keyboard. This functionality might be particularly valuable in situations where GUIs are not organized into a navigation hierarchy.

Console Environment—Command Zone Replacement:

This use case extends the idea of direct navigation for GUIs to voice versions of all command zone commands. For example, it allows an operator to use a voice command to directly call up a GUI as well as highlight or focus on a specific detail of that GUI. The grammar identified by the speech integrator 310 and used by the speech engine 308 could be built based on the set of GUIs defined for use at the operator console and the set of zone commands used with those GUIs. This use case can help to reduce or eliminate the need to use a keyboard to issue commands to the operator console 110.

Console Environment—Mobile Situation Awareness:

Assume an operator leaves an operator console to take a break. Ordinarily, the operator loses situational awareness when away from the console. In accordance with this disclosure, the operator console 110 can audibly relay key process parameters, alarms, or other data to the operator, such as via a wireless headset 212. In some embodiments, this could be implemented as follows. A speech-enabled overview GUI can be defined that captures the parameters, alarm groups, or other data that the operator needs to know about (the contents could be kept to a minimum). The operator could call up this GUI (possibly using a voice command as described above) prior to stepping away from his or her console 110, and this GUI could then initiate voice updates to the operator via the headset 212. In particular embodiments, the operator could always be informed of alarms that would trigger alarm lights at the console 110. This approach allows the operator to maintain situational awareness when away from the console 110 in a hands-free, eyes-free form.

Collaboration Station Environment—Navigation:

Assume a collaboration station is displaying information on a large screen, such as on a wall, and users cannot touch the screen to navigate and call up information. In accordance with this disclosure, voice commands can be used to navigate within the GUI, such as to zoom into or out of specific areas of an industrial facility. The grammar identified by the speech integrator 310 and used by the speech engine 308 could be built based on navigation commands and content that can be accessed at the collaboration station.

Collaboration Station Environment—Keyboard Alternative:

In some situations, an onscreen keyboard can be available at a collaboration station for text entry. In accordance with this disclosure, voice dictation can be used to enter free text in the collaboration station rather than using the onscreen keyboard. A specific example could include updating notes in a MICROSOFT WORD document or other text document.

Note that these use cases are only examples of how voice augmentation can be supported and used at operator consoles 110. A wide variety of other use cases could be developed based on the ability to audibly interact with one or more operators. Also note that the operator consoles 110 can include various additional functionality related to voice augmentation. For example, the speech engine 308 could perform any suitable processing to help reduce background or ambient noise when analyzing speech from an operator. As another example, the speech integrator 310 could be configured to handle incomplete or ambiguous utterances in any suitable manner. For instance, the speech integrator 310 could be designed to ignore incomplete or ambiguous utterances and request (via the speech engine 308) that an operator speak more clearly or slowly. The speech integrator 310 could also be designed to identify possible interpretations of incomplete or ambiguous utterances and request that an operator identify the correct interpretation (if any).

Although FIGS. 2 and 3 illustrate one example of an operator console 110 with voice augmentation, various changes may be made to FIGS. 2 and 3. For example, the form of the operator console 110 shown in FIG. 2 is for illustration only. Operator consoles, like most computing devices, can come in a wide variety of configurations, and FIG. 2 does not limit this disclosure to any particular configuration of operator console. Also, various components in FIG. 3 could be combined, further subdivided, or omitted and additional components could be added according to particular needs. For instance, the components 308-310 could be integrated into a single functional unit or subdivided into more than two units, and the databases 120a-120b could be combined into a single database or subdivided into more than two databases. As another example, the operator console 110 could use the speech engine 308 to either receive and recognize audio data or generate synthesized speech (but not both). In addition, as noted above, various components shown in FIG. 3 could be implemented within the operator console 110 or be implemented away from (but accessible at) the operator console 110.

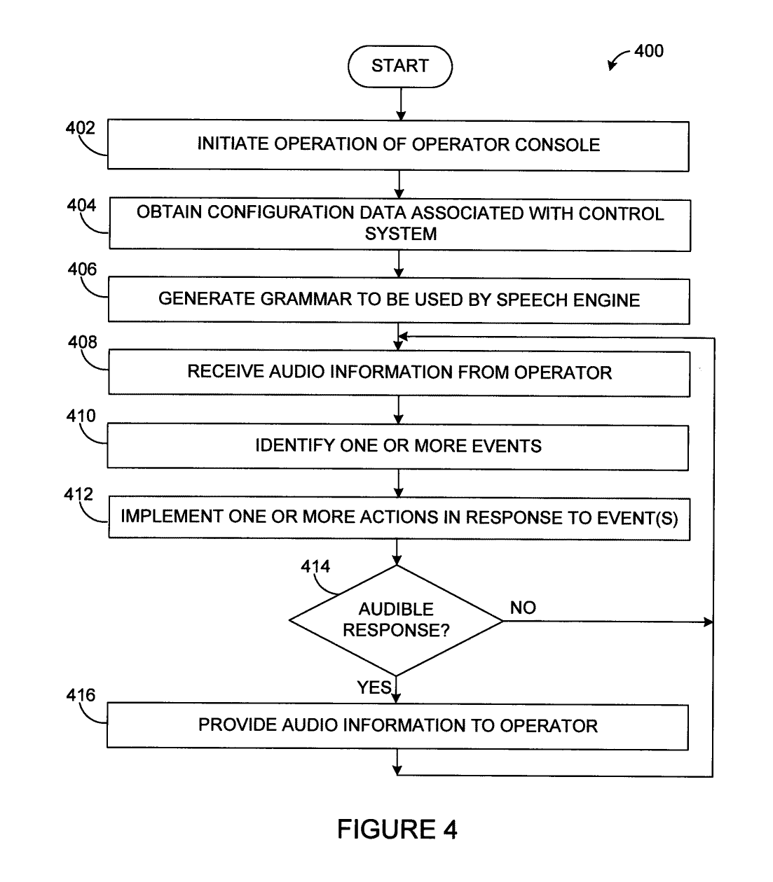

FIG. 4 illustrates an example method 400 for using an operator console with voice augmentation according to this disclosure. For ease of explanation, the method 400 is described with respect to the operator console 110 shown in FIGS. 2 and 3. However, the method 400 could be used with any other suitable operator console.

As shown in FIG. 4, operation of an operator console is initiated at step 402. This could include, for example, the processing device 114 of the operator console 110 booting up and performing various initial actions, such as establishing communications with an underlying control system.

Configuration data associated with a control system is obtained at step 404, and at least one grammar to be used by a speech engine is generated using the configuration data at step 406. This could include, for example, the speech integrator 310 obtaining configuration data associated with the underlying control system from the database 120b. The configuration data could include definitions of various process variables, controllers, assets, trends, alarms, reports, and displays available in the underlying control system. These types of information can define the grammars spoken by console operators for most or all of the operators' typical functions.

Audio information is received from an operator at step 408, and one or more recognition events are identified at step 410. This could include, for example, the speech engine 308 receiving audio data from an audio device 306, such as in a headset 212. This could also include the speech engine 308 analyzing the audio data using the identified grammar to detect one or more recognized words or phrases.

One or more actions can be implemented in the underlying control system in response to the recognition event(s) at step 412. This could include, for example, the speech integrator 310 issuing commands to change one or more GUIs 304 in the HMI 302. This could also include the speech integrator 310 issuing commands to retrieve or change process variables values, to acknowledge alarms or notifications, or to perform any other action(s) with respect to the database 120a or HMI 302. A determination is made whether an audible response needs to be provided to the operator at step 414. If so, the audible response is provided to the operator at step 416. This could include, for example, the speech engine 308 providing audio data to an audio device 306, such as in the headset 212. The audio data could acknowledge that a certain function has been performed or provide requested data to the operator.

Although FIG. 4 illustrates one example of a method 400 for using an operator console with voice augmentation, various changes may be made to FIG. 4. For example, while shown as a series of steps, various steps in FIG. 4 could overlap, occur in parallel, occur in a different order, or occur any number of times. Also, FIG. 4 is meant to illustrate one way in which voice augmentatiorn can be used at an operator console 110. However, as noted above, there are many other ways in which voice augmentation can be used at an operator console 110. For instance, an operator console 110 could be configured to produce synthesized speech without receiving any audio data or identifying any recognition events.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving first audio data from an operator associated with an industrial control and automation system;
identifying one or more recognition events associated with the first audio data, each recognition event associated with at least a portion of the first audio data that has been recognized using at least one grammar; and
performing one or more actions using the industrial control and, automation system based on the one or more recognition events;
wherein the at least one grammar is based on information associated with the industrial control and automation system.

2. The method of claim 1, further comprising:
generating the at least one grammar based on the information associated with the industrial control and automation system.

3. The method of claim 2, wherein the information associated with the industrial control and automation system comprises definitions of process variables, controllers, assets, trends, alarms, reports, and displays available in the industrial control and automation system.

4. The method of claim 1, wherein:
the one or more recognition events comprise a request to at least one of: display, move, and read data from a graphical user interface; and
the one or more actions comprise at least one of: displaying, moving, and reading the data from the graphical user interface.

5. The method of claim 1, wherein:
the one or more recognition events comprise a request to at least one of: silence, acknowledge, and annunciate an alarm; and
the one or more actions comprise at least one of: silencing, acknowledging, and annunciating the alarm.

6. The method of claim 1, wherein:
the one or more recognition events comprise a request to add a comment; and
the one or more actions comprise receiving and storing the comment or information based on the comment.

7. The method of claim 1, wherein:
the one or more recognition events comprise a request to at least one of: read a parameter and identify an update to a parameter; and
the one or more actions comprise at least one of: reading a value of the parameter and reading an updated value of the parameter.

8. The method of claim 1, further comprising:
generating second audio data for output to the operator.

9. The method of claim 8, wherein the second audio data comprises at least one of:
information associated with the industrial control and automation system requested by the operator; and
an acknowledgement that the one or more recognition events have been received.

10. An apparatus comprising:
at least one processing device configured to:
receive first audio data from an operator associated with an industrial control and automation system;
identify one or more recognition events associated with the first audio data, each recognition event associated with at least a portion of the first audio data that has been recognized using at least one grammar; and
initiate performance of one or more actions using the industrial control and automation system based on the one or more recognition events;
wherein the at least one grammar is based on information associated with the industrial control and automation system.

11. The apparatus of claim 10, wherein the at least one processing device is further configured to generate the at least one grammar based on the information associated with the industrial control and automation system.

12. The apparatus of claim 11, wherein the information associated with the industrial control and automation system comprises definitions of process variables, controllers, assets, trends, alarms, reports, and displays available in the industrial control and automation system.

13. The apparatus of claim 10, wherein:
the one or more recognition events comprise a request to at least one of: display, move, and read data from a graphical user interface; and
the one or more actions comprise at least one of: displaying, moving, and reading the data from the graphical user interface.

14. The apparatus of claim 10, wherein:
the one or more recognition events comprise a request to at least one of: silence, acknowledge, and annunciate an alarm; and
the one or more actions comprise at least one of: silencing, acknowledging, and annunciating the alarm.

15. The apparatus of claim 10, wherein:
the one or more recognition events comprise a request to add a comment; and
the one or more actions comprise receiving and storing the comment: or information based on the comment.

16. The apparatus of claim 10, wherein:
the one or more recognition events comprise a request to at least one of: read a parameter and identify an update to a parameter; and
the one or more actions comprise at least one of: reading a value of the parameter and reading an updated value of the parameter.

17. The apparatus of claim 10, wherein the at least one processing device is further configured to generate second audio data for output to the operator, the second audio data comprising at least one of:
information associated with the industrial control and automation system requested by the operator; and
an acknowledgement that the one or more recognition events have been received.

18. A non-transitory computer readable medium embodying a computer program, the computer program comprising computer readable program code for:
receiving first audio data from an operator associated with an industrial control and automation system;
identifying one or more recognition events associated with the first audio data, each recognition event associated with at least a portion of the first audio data that has been recognized using at least one grammar; and
initiating performance of one or more actions using the industrial control and automation system based on the one or more recognition events;
wherein the at least one grammar is based on information associated with the industrial control and automation system.

19. The computer readable medium of claim 18, wherein the computer program further comprises computer readable program code for:
generating the at least one grammar based on the information associated with the industrial control and automation system.

20. The computer readable medium of claim 19, wherein the information associated with the industrial control and automation system comprises definitions of process variables, controllers, assets, trends, alarms, reports, and displays available in the industrial control and automation system.
